(19) United States
(12) Patent Application Publication
(10) Pub. No.: US 2024/0308302 A1
(43) Pub. Date: Sep. 19, 2024

(54) Retractable Vehicle Windshield Sunshade Device

(71) Applicant: Talona Talbot, Clearfield, UT (US)

(72) Inventor: Talona Talbot, Clearfield, UT (US)

(21) Appl. No.: 18/464,830

(22) Filed: Sep. 11, 2023

Related U.S. Application Data
(60) Provisional application No. 63/452,567, filed on Mar. 16, 2023.

(51) Int. Cl. B60J 3/02

(52) U.S. Cl. CPC B60J 3/02

(57) ABSTRACT

A retractable vehicle windshield sunshade device. The device is primarily comprised of a base that houses at least one sunshade or sun screen, and at least one upper attachment member. The base is designed to attach to the dashboard of a vehicle at least one attachment fastener. The upper attachment member attaches to the interior of a vehicle windshield also via a fastener such that when the user desires to deploy the sun screen/shade over the windshield, a user can pull the screen from the base toward the upper attachment member. Then, an attachment point on the screen can be removably secured to an attachment point on the upper attachment member to hold the screen in position.

### CROSS-REFERENCE TO RELATED APPLICATION

The present application claims priority to, and the benefit of, U.S. Provisional Application No. 63/452,567, which was filed on Mar. 16, 2023, and is incorporated herein by reference in its entirety.

### FIELD OF THE INVENTION

The present invention relates generally to the field of vehicle sunshade devices. More specifically, the present invention relates to a retractable vehicle windshield sunshade device that can be mounted on a dashboard and the interior surface of a vehicle windshield, wherein a screen can be extended from the dashboard to the windshield to block sunlight. Accordingly, the present disclosure makes specific reference thereto. Nonetheless, it is to be appreciated that aspects of the present invention are also equally applicable to other like applications, devices, and methods of manufacture.

### BACKGROUND

Many individuals use vehicle sunshades to keep the sun out of their vehicle while not in use by placing the sunshade over the interior of the vehicle windshield. However, sunshades must be manually placed on the dash of a vehicle behind a windshield during use and removed from the windshield while not in use. This can become a tiring process to repeat daily. In addition, the sunshade must be stored within the vehicle when not in use, which may be undesirable.

Therefore, there exists a long-felt need in the art for an improved vehicle sunshade. More specifically, there exists a long-felt need in the art for a retractable vehicle windshield sunshade device that can be easily deployed over a vehicle windshield to block the sun and prevent a car from overheating. In addition, there exists a long-felt need in the art for a retractable vehicle windshield screen device that can be easily stored in a convenient location when not in use.

The subject matter disclosed and claimed herein, in one embodiment thereof, comprises a retractable vehicle windshield sunshade device. The device is primarily comprised of a base that houses at least one screen, and at least one upper attachment member. The base is designed to attach to the dashboard of a vehicle via at least one attachment fastener. The upper attachment member attaches to the interior of a vehicle windshield also via a fastener. When a user desires to deploy the sun screen/shade over the windshield, a user can pull the screen from the base towards the upper attachment member. Then, an attachment point on the screen can be removably secured to an attachment point on the upper attachment member to hold the screen in position. When not in use, the screen can rescind into the housing around a spool.

In this manner, the retractable vehicle windshield sunshade device of the present invention accomplishes all the foregoing objectives and provides an improved vehicle sunshade. More specifically, the device can be easily deployed over a vehicle windshield to block the sun and prevent a car from overheating. In addition, the device can be retracted and easily stored on the dash of the vehicle in a convenient location when not in use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable vehicle windshield sunshade device. The device is primarily comprised of a base that houses at least one screen, and at least one upper attachment member. The base is designed to attach to the dashboard of a vehicle via at least one attachment fastener. The base is preferably curved such that the shape of the base mimics the curvature of the dashboard. To allow the base to achieve the curvature as needed, the base may be comprised of at least one flex point that allows the base to flex or bend.

The base houses at least one screen that is preferably a reflective sunshade/screen that repels sunlight to prevent the interior of a vehicle from increasing in temperature and being exposed to UV light (to avoid UV light damage). The screen is preferably made from UV-resistant, flexible fabric or a mylar and/or aluminum foil material. The screen is stored within the base when not in use around at least one rotating spool housed within the base. The first end of the screen is preferably fixedly attached to/around the spool. The second end of the screen is comprised of at least one frame member that is preferably curved to follow the curvature of a vehicle windshield and may be flexible as a result. When a user desires to deploy the screen, the screen can be pulled from at least one opening of the base.

The device is also comprised of at least one upper attachment member that is preferably curved to follow the curvature of a vehicle windshield. The member may be comprised of at least one flex point that allows the member to flex to provide more curvature as needed. The rear surface of the member preferably attaches to a vehicle windshield via at least one attachment fastener. The front surface of the member is comprised of at least one screen fastener that allows the screen to temporarily attach to the member via at least one attachment point of the frame of the screen.

The present invention is also comprised of a method of using the device. First, a device is provided comprised of a base comprised of a spool and a fastener, a screen comprised of an attachment point wherein the screen is attached to the spool, and an upper attachment member comprised of a fastener and a screen fastener. Next, the base is secured to a dashboard of a vehicle via the fastener of the base. Then, the upper attachment member is attached to the windshield of a vehicle via a fastener of the member. When a user desires to deploy the screen to cover a windshield to block sunlight from entering a vehicle, the user can pull the screen upward from an opening in the base and toward the attachment member, such that the attachment point of the screen can be removably secured to the fastener of the member. When a user desires to no longer use the screen to block the windshield, the attachment point of the screen can be removed from the fastener of the attachment member and the screen can be retracted around the spool back into the base.

Accordingly, the retractable vehicle windshield sunshade device of the present invention is particularly advantageous as it provides an improved vehicle sunshade. More specifically, the device can be easily deployed over a vehicle windshield to block the sun and prevent a car from overheating. In addition, the device can be retracted and easily stored on the dash of the vehicle in a convenient location when not in use. In this manner, the retractable vehicle windshield sunshade device overcomes the limitations of existing vehicle sunshades known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a retractable vehicle windshield sunshade device of the present invention wherein the screen is extended in accordance with the disclosed architecture;

FIG. 2 illustrates a perspective view of one potential embodiment of a retractable vehicle windshield sunshade device of the present invention mounted within a vehicle in accordance with the disclosed architecture;

FIG. 3 illustrates a perspective view of one potential embodiment of a retractable vehicle windshield sunshade device of the present invention mounted within a vehicle with the screen extended in accordance with the disclosed architecture; and

FIG. 4 illustrates a flowchart of a method of using one potential embodiment of a retractable vehicle windshield sunshade device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved vehicle sunshade. More specifically, there exists a long-felt need in the art for a retractable vehicle windshield sunshade device that can be easily deployed over a vehicle windshield to block the sun and prevent a car from overheating. In addition, there exists a long-felt need in the art for a retractable vehicle windshield screen device that can be easily stored in a convenient location when not in use.

The present invention, in one exemplary embodiment, is comprised of a retractable vehicle windshield sunshade device primarily comprised of a base that houses at least one screen, and at least one upper attachment member. The base is designed to attach to the dashboard of a vehicle via at least one attachment fastener, and is preferably curved such that the shape of the base mimics the curvature of the dashboard. To allow the base to achieve the curvature as needed, the base may be comprised of at least one flex point. The flex point allows the base to further flex or bend.

The base houses at least one screen. The screen is preferably a reflective sunshade/screen that repels sunlight to prevent the interior of a vehicle from increasing in temperature and being exposed to UV light (to avoid UV light damage). The screen is preferably made from UV-resistant, flexible fabric or a mylar and/or aluminum foil material. The screen is stored within the base when not in use around at least one rotating spool housed within the base. The first end of the screen is preferably fixedly attached to/around the spool. The second end of the screen is comprised of at least one frame member that is preferably curved to follow the curvature of a vehicle windshield and may be flexible as a result. When a user desires to deploy the screen, the screen can be pulled from at least one opening of the base.

The device is also comprised of at least one upper attachment member. The member is preferably curved to follow the curvature of a vehicle windshield and may be comprised of at least one flex point that allows the member to flex to provide more curvature as needed. The rear surface of the member preferably attaches to a vehicle windshield via at least one attachment fastener. The front surface of the member is comprised of at least one screen fastener that allows the screen to temporarily attach to the member via at least one attachment point of the frame of the screen.

The present invention is also comprised of a method of using the device. First, a device is provided comprised of a base comprised of a spool and a fastener, a screen comprised of an attachment point wherein the screen is attached to the spool, and an upper attachment member comprised of a fastener and a screen fastener. Next, the base is secured to a dashboard of a vehicle via the fastener of the base. Then, the upper attachment member is attached to the windshield of a vehicle via a fastener of the member. When a user desires to deploy the screen to cover a windshield to block sunlight from entering a vehicle, the user can pull the screen upward from an opening in the base and toward the attachment member, such that the attachment point of the screen can be removably secured to the fastener of the member. When a user desires to no longer use the screen to block the windshield, the attachment point of the screen can be removed from the fastener of the attachment member and the screen can be retracted around the spool back into the base.

Accordingly, the retractable vehicle windshield sunshade device of the present invention is particularly advantageous as it provides an improved vehicle sunshade. More specifically, the device can be easily reached and deployed by a user over a vehicle windshield to block the sun and prevent a car from overheating. In addition, the device can be retracted and easily stored on the dash of the vehicle in a convenient location when not in use. In this manner, the retractable vehicle windshield sunshade device overcomes the limitations of existing vehicle sunshades known in the art.

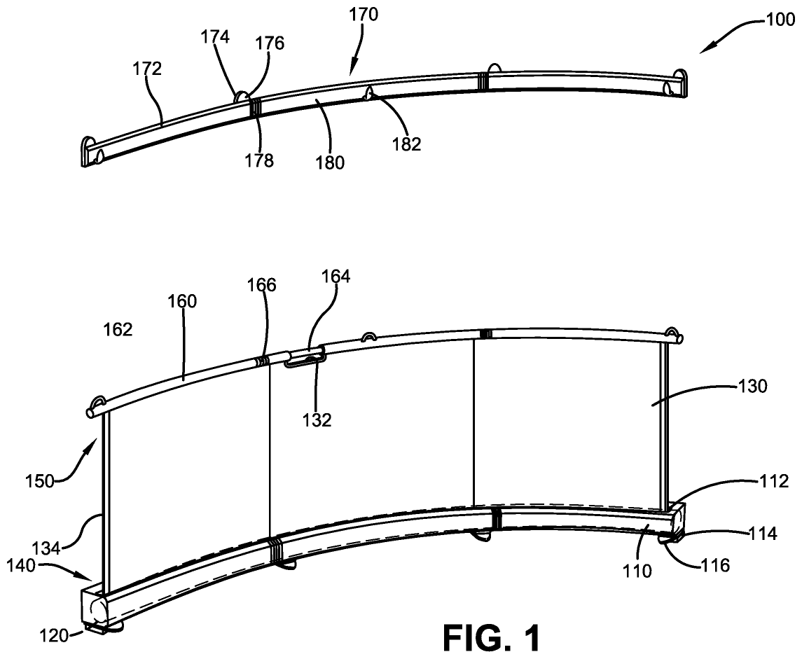

Referring initially to the drawings, FIG. 1 illustrates a perspective view of one potential embodiment of a retractable vehicle windshield sunshade device 100 of the present invention wherein the screen 130 is extended in accordance with the disclosed architecture. The device 100 is primarily comprised of a base 110 that houses at least one screen 130, and at least one upper attachment member 170. The base 110, frame member 160, and upper attachment member 170 are preferably comprised of a flexible composite material such as, but not limited to, plastic.

The base 110 is designed to attach to the dashboard 10 of a vehicle. The base 110 preferably attaches to the dashboard 10 via at least one attachment fastener 114. The fastener 114 is preferably an adhesive fastener 114 with at least one pull tab 116 that allows the fastener 114 of the base 110 to be easily removed from a dashboard 10 by pulling the tab 116. In different embodiments, the fastener 114 may be any fastener type known in the art such as, but not limited to, suction cup, screw, bolt, magnet, adhesive, etc.

The base 110 is preferably curved such that the shape of the base 110 mimics the curvature of the dashboard 10. To allow the base 110 to achieve the curvature as needed, the base 110 may be comprised of at least one flex point 118. The flex point 118 is preferably comprised of a corrugated material that allows the base 110 to flex or bend.

The base 110 houses at least one screen 130. The screen 130 is preferably a reflective sunshade/screen that repels sunlight to prevent the interior of a vehicle from increasing in temperature and being exposed to UV light (to avoid UV light damage). The screen 130 is preferably made from UV-resistant, flexible fabric. In another embodiment, the screen 130 may be comprised of a mylar and/or aluminum foil material. The screen 130 is preferably comprised of a reinforced edge 134 to add stability to the screen 130. The screen 130 is stored within the base 110 when not in use around at least one rotating spool 120 housed within the base 110. The spool 120 is preferably, but not limited to, a spring-loaded spool.

The first end 140 of the screen 130 is preferably fixedly attached to/around the spool 120. The second end 150 of the screen 130 is comprised of at least one frame member 160. The frame member 160 is preferably curved to follow the curvature of a vehicle windshield 12 and may be flexible as a result. The frame member 160 may be comprised of at least one flex point 118. The flex point 118 is preferably comprised of a corrugated material that allows the frame member 160 to flex to provide more curvature as needed.

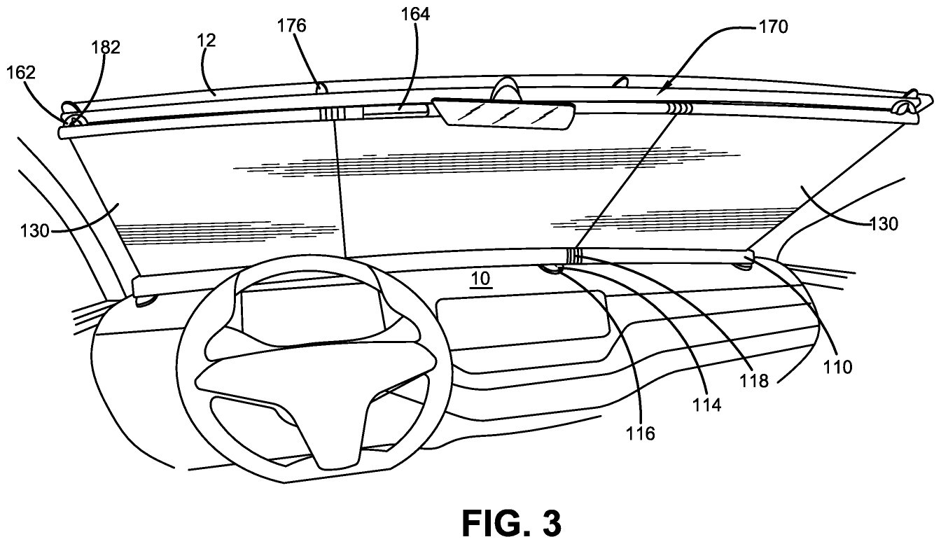

When a user desires to deploy the screen 130, the screen 130 can be pulled from at least one opening 112 of the base 110, as seen in FIG. 3. More specifically, a user can pull the screen 130 from the base 110 via at least one handle 164 of the frame member 160. In one embodiment, the handle 164 can be accessed via at least one cutout 132 in the screen 130.

The device 100 is also comprised of at least one upper attachment member 170. The member 170 is preferably curved to follow the curvature of a vehicle windshield 12. Further, the upper attachment member 170 would preferably be clear or translucent. The member 170 may be comprised of at least one flex point 178. The flex point 178 is preferably comprised of a corrugated material that allows the member 170 to flex to provide more curvature as needed.

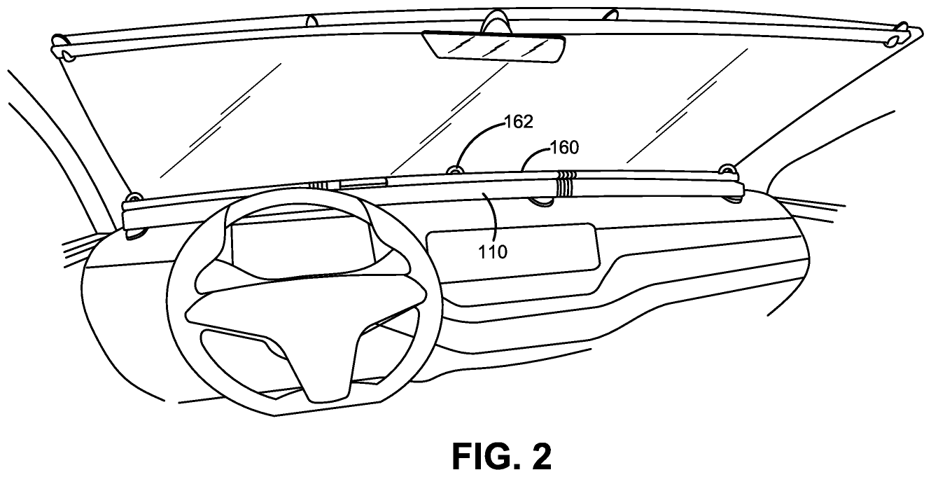

The rear surface 172 of the member 170 preferably attaches to a vehicle windshield 12 via at least one attachment fastener 174, as seen in FIG. 2. The fastener 174 is preferably an adhesive fastener 174 with at least one pull tab 176 that allows the member 170 to be easily removed from a windshield 12 by pulling the fastener 174. In different embodiments, the fastener 174 may be any fastener type known in the art such as, but not limited to, suction cup, screw, bolt, magnet, adhesive, etc.

The front surface 180 of the member 170 is comprised of at least one screen fastener 182 that allows the screen to temporarily attach to the member 170 via at least one attachment point 162 of the frame 160 of the screen 130, as seen in FIG. 3. The screen fastener 182 is preferably a hook, but may be any fastener known in the art such as, but not limited to, a clip, a clamp, etc. The attachment point 162 is preferably, but not limited to, a loop, a clip, a clamp, etc.

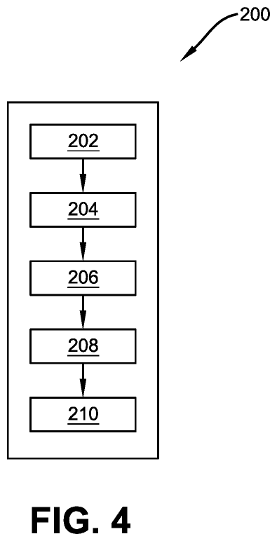

The present invention is also comprised of a method of using 200 the device 100, as seen in FIG. 4. First, a device 100 is provided comprised of a base 110 comprised of a spool 120 and a fastener 114, a screen 130 comprised of an attachment point 162 wherein the screen 130 is attached to the spool 120, and an upper attachment member 170 comprised of a fastener 174 and a screen fastener 182 [Step 202]. Next, the base 110 is secured to a dashboard 10 of a vehicle via the fastener 114 of the base 110 [Step 204]. Then, the upper attachment member 170 is attached to the windshield 12 of a vehicle via a fastener 174 of the member 170 [Step 206]. When a user desires to deploy the screen 130 to cover a windshield 12 to block sunlight from entering a vehicle, the user can pull the screen 130 upward from an opening 112 in the base 110 and toward the attachment member 170, such that the attachment point 162 of the screen 130 can be removably secured to the fastener 182 of the member 170 [Step 208]. When a user desires to no longer use the screen 130 to block the windshield 12, the attachment point 162 of the screen 130 can be removed from the fastener 182 of the attachment member 170 and the screen 160 can be retracted around the spool 120 back into the base 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “retractable vehicle windshield sunshade device” and “device” are interchangeable and refer to the retractable vehicle windshield sunshade device 100 of the present invention.

Notwithstanding the foregoing, the retractable vehicle windshield sunshade device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the retractable vehicle windshield sunshade device 100 as shown in the FIGS. are for illustrative purposes only, and that many other sizes and shapes of the retractable vehicle windshield sunshade device 100 are well within the scope of the present disclosure. Although the dimensions of the retractable vehicle windshield sunshade device 100 are important design parameters for user convenience, the retractable vehicle windshield sunshade device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retractable vehicle windshield sunshade device comprising:
a base comprised of a first fastener, an opening, and a spool;
a screen attached to the spool, the screen comprised of an attachment member; and
an upper attachment member comprised of a second fastener and a third fastener.

2. The retractable vehicle windshield sunshade device of claim 1, wherein the screen is comprised of a UV-resistant material.

3. The retractable vehicle windshield sunshade device of claim 1, wherein the base is comprised of a flexible material.

4. The retractable vehicle windshield sunshade device of claim 1, wherein the upper attachment member is comprised of a flexible material.

5. The retractable vehicle windshield sunshade device of claim 1, wherein the first fastener and the second fastener are comprised of an adhesive fastener.

6. The retractable vehicle windshield sunshade device of claim 1, wherein the first fastener and the second fastener are comprised of a suction cup.

7. A retractable vehicle windshield sunshade device comprising:
a base comprised of a first fastener comprised of a first pull tab, an opening, a first flex point, and a spool;
a screen attached to the spool, the screen comprised of an attachment member; and
an upper attachment member comprised of a second fastener comprised of a second pull tab, a second flex point, and a third fastener.

8. The retractable vehicle windshield sunshade device of claim 7, wherein the screen is comprised of an aluminum foil material.

9. The retractable vehicle windshield sunshade device of claim 7, wherein the first flex point is comprised of a corrugated flex point.

10. The retractable vehicle windshield sunshade device of claim 7, wherein the second flex point is comprised of a corrugated flex point.

11. The retractable vehicle windshield sunshade device of claim 7, wherein the first fastener and the second fastener are comprised of an adhesive fastener.

12. The retractable vehicle windshield sunshade device of claim 7, wherein the first fastener and the second fastener are comprised of a suction cup.

13. The retractable vehicle windshield sunshade device of claim 7, wherein the screen is comprised of a reinforced edge.

14. The retractable vehicle windshield sunshade device of claim 7, wherein the attachment member is comprised of a loop.

15. The retractable vehicle windshield sunshade device of claim 7, wherein the third fastener is comprised of a hook.

16. The retractable vehicle windshield sunshade device of claim 7, wherein the third fastener is comprised of a clip or a clamp.

17. The retractable vehicle windshield sunshade device of claim 7, wherein the screen is comprised of a handle.

18. The retractable vehicle windshield sunshade device of claim 7, wherein the spool is comprised of a spring-loaded spool.

19. The retractable vehicle windshield sunshade device of claim 7, wherein the screen is comprised of a flexible frame member.

20. A method of using a retractable vehicle windshield sunshade device, the method comprising the following steps:
providing a retractable vehicle windshield sunshade device comprised of a base comprised of a spool and a first fastener, a screen attached to the spool comprised of an attachment point, and an upper attachment member comprised of a second fastener and a screen fastener;
securing the base to a dashboard of a vehicle via the first fastener;
attaching the upper attachment member to a windshield of a vehicle via the second fastener;
pulling the screen upward from an opening in the base and towards the attachment member such that the attachment point of the screen can be removably secured to the second fastener;
removing the screen from the second fastener; and
retracting the screen back into the base around the spool.
